(19) United States
(12) Patent Application Publication
(10) Pub. No.: US 2026/0035637 A1
(43) Pub. Date: Feb. 5, 2026

(54) SEMICONDUCTOR CLEANING AGENT COMPOSITION

(71) Applicant: NIPPON SHOKUBAI CO., LTD., Osaka-shi, Osaka (JP)

(72) Inventor: Takako HARIGAE, Osaka (JP)

(21) Appl. No.: 18/998,067

(22) PCT Filed: Jul. 25, 2023
(86) PCT No.: PCT/JP2023/027090

§ 371 Date: Jan. 23, 2025

(30) Foreign Application Priority Data
Jul. 25, 2022 (JP) 2022-117727

(51) Int. Cl. C11D 3/37; C11D 1/722; C11D 3/00; C11D 3/30

(52) U.S. Cl. CPC C11D 3/3757; C11D 1/722; C11D 3/0047; C11D 3/30; C11D 2111/22

(57) ABSTRACT

The present invention aims to provide a semiconductor cleaning agent composition that exhibits a high ability to remove ceria particles remaining as metal residues on a substrate. The present invention relates to a semiconductor cleaning agent composition, containing: a polymer having a structural unit derived from a carboxylic acid-based monomer; and a pH adjuster, the polymer having a weight average molecular weight of 3100 or more, the pH adjuster being one or more compounds selected from the group consisting of a metal hydroxide and an amine compound, and the semiconductor cleaning agent composition having a pH of 7 or higher.

### TECHNICAL FIELD

The present invention relates to semiconductor cleaning agent compositions.

### BACKGROUND ART

Conventionally known wafer surface planarization processes in semiconductor manufacturing processes include a chemical-mechanical-planarization/polishing (CMP) process. A CMP process leaves metal residues such as abrasive grains and polishing debris on the wafer surface, and cleaning is performed to remove such residues. Various cleaning agents for such a CMP process have been known so far. For example, Patent Literature 1 discloses a cleaning composition containing ammonium that forms a salt with a specific water-soluble polymer as a cleaning composition for use in cleaning after a CMP process.

### CITATION LIST

### Patent Literature

Patent Literature 1: JP 2006-41494 A

### SUMMARY OF INVENTION

### Technical Problem

However, conventional cleaning agents for a CMP process are still insufficient in removing metal residues remaining on a wafer after a CMP process, and have room for improvement. In particular, conventional cleaning agents lack an ability to remove ceria (cerium oxide: CeO₂) particles. Thus, when an abrasive containing ceria particles is used, such cleaning agents fail to sufficiently remove ceria particles remaining on a wafer, resulting in problems such as adhesion of the remaining components to the substrate surface.

In view of the aforementioned current situation, the present invention aims to provide a semiconductor cleaning agent composition that exhibits a high ability to remove ceria particles remaining as metal residues on a substrate.

### Solution to Problem

In order to solve the above problems, the present inventors have conducted various studies on semiconductor cleaning agent compositions and have found that a cleaning agent composition containing a specific polymer and a pH adjuster and having a pH of 7 or higher exhibits a high ability to remove metal residues including ceria particles, thereby completing the present invention.

Specifically, the present invention is described in the following <1> to <3>.

<1> A semiconductor cleaning agent composition, containing: a polymer having a structural unit derived from a carboxylic acid-based monomer; and a pH adjuster, the polymer having a weight average molecular weight of 3100 or more, the pH adjuster being one or more compounds selected from the group consisting of a metal hydroxide and an amine compound, and the semiconductor cleaning agent composition having a pH of 7 or higher.

<2> The semiconductor cleaning agent composition according to <1>, wherein the amine compound includes one or more compounds selected from the group consisting of compounds represented by the following formula (1) and compounds represented by the following formula (2):

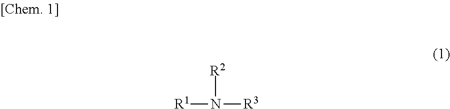

wherein R¹, R², and R³ are the same as or different from each other and each represent a hydrogen atom or a C1-C18 hydrocarbon group optionally having a substituent; and at least two selected from R¹, R², and R³ are optionally linked to each other to form a ring,

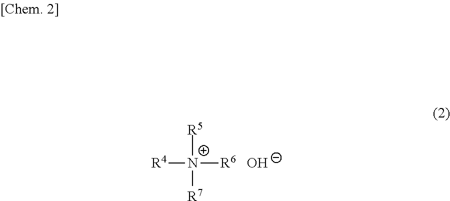

wherein R⁴, R⁵, R⁶, and R⁷ are the same as or different from each other and each represent a hydrogen atom or a C1-C18 hydrocarbon group optionally having a substituent.

<3> The semiconductor cleaning agent composition according to <1> or <2>, containing at least one of a compound represented by the following formula (3) or a compound represented by the following formula (4):

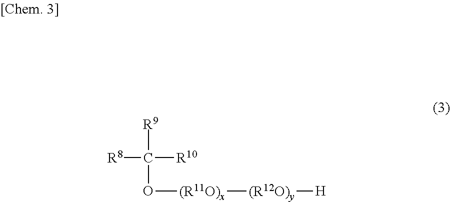

wherein R⁸, R⁹, and R¹⁰ are the same as or different from each other and each represent a hydrogen atom or an alkyl group; R¹¹ and R¹² are the same as or different from each other and each represent an alkylene group; x and y are the same as or different from each other and each represent an integer of 0 to 50; and (x+y) is an integer of 1 or more,

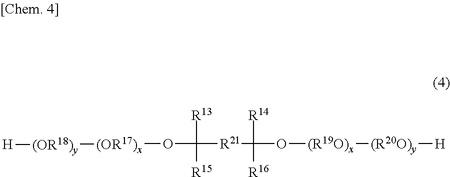

wherein R¹³, R¹⁴, R¹⁵, and R¹⁶ are the same as or different from each other and each represent a hydrogen atom or an alkyl group; R¹⁷, R¹⁸, R¹⁹, R²⁰, and R²¹ are the same as or different from each other and each represent an alkylene group or an alkynylene group; x and y are the same as or different from each other and each represent an integer of 0 to 50; and (x+y) is an integer of 1 or more.

### Advantageous Effects of Invention

The semiconductor cleaning agent composition of the present invention can exhibit a high ability to remove ceria particles remaining as metal residues on a substrate.

### DESCRIPTION OF EMBODIMENTS

The present invention is described in detail below. A combination of two or more of individual preferred embodiments of the present invention described below is also a preferred embodiment of the present invention.

### Semiconductor Cleaning Agent Composition

### <Polymer>

The semiconductor cleaning agent composition of the present disclosure contains a polymer having a structural unit (A) derived from a carboxylic acid-based monomer.

(Structural Unit (A) Derived from Carboxylic Acid-Based Monomer)

The semiconductor cleaning agent composition of the present disclosure contains a polymer having a structural unit (A) derived from a carboxylic acid-based monomer. In the present disclosure, the carboxylic acid-based monomer refers to a carboxy group-containing monomer and/or a salt thereof. The polymer preferably has a structural unit 10 derived from a carboxy group-containing monomer and/or a structural unit derived from a salt thereof.

In the present disclosure, for example, a “structural unit (A) derived from a carboxy group-containing monomer” refers to a structural unit having a structure in which at least one carbon-carbon double bond in the carboxy group-containing monomer is replaced with a carbon-carbon single bond. For example, when the carboxy group-containing monomer is acrylic acid (CH₂═CHCOOH), the structural unit derived from the acrylic acid can be represented by —CH₂—CH(—COOH)—. In the present disclosure, the structural unit derived from a carboxy group-containing monomer is not limited to a structural unit actually formed by polymerization of a carboxy group-containing monomer, and may be a structural unit formed by a different method as long as it has the same structure as a structural unit having a structure in which at least one carbon-carbon double bond in the carboxy group-containing monomer is replaced with a carbon-carbon single bond.

The carboxy group-containing monomer may be any monomer having a structure containing a polymerizable unsaturated bond (carbon-carbon double bond) and a carboxy group. Examples of the monomer include unsaturated carboxylic acid compounds such as acrylic acid, methacrylic acid, α-hydroxyacrylic acid, α-hydroxymethylacrylic acid, maleic acid, fumaric acid, itaconic acid, crotonic acid, and 2-methylene glutaric acid.

Non-limiting examples of a salt of the carboxy group-containing monomer include metal salts, ammonium salts, and organic amine salts of the unsaturated carboxylic acid compounds. Preferred salts of a carboxylic acid include a potassium carboxylate, a sodium carboxylate, an ammonium carboxylate, and a quaternary amine of a carboxylic acid.

These carboxylic acid-based monomers may be used alone or in combination of two or more kinds.

In the polymer, the proportion of the structural unit derived from the carboxylic acid-based monomer is preferably 10 to 100 mol % based on 100 mol % of all structural units. It is more preferably 20 to 100 mol %, still more preferably 40 to 100 mol % based on 100 mol % of all structural units.

(Structural Unit Derived from Different Monomer)

The polymer of the present disclosure may contain one or two or more structural units derived from a monomer other than the structural unit (A) derived from a carboxylic acid-based monomer (hereinafter also referred to as a “structural unit derived from a different monomer”).

The structural unit derived from a different monomer is a structural unit in which a carbon-carbon double bond (C═C) of an ethylenically unsaturated monomer other than the carboxylic acid-based monomer is replaced with a carbon-carbon single bond (C—C) to form a bond with an adjacent structural unit. As long as the structural unit derived from a different monomer corresponds in structure to the aforementioned structural unit, the structural unit does not need to be one formed by actually replacing a carbon-carbon double bond of the monomer with a carbon-carbon single bond.

Specific examples of the different monomer include hydroxy group-containing alkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, and α-hydroxymethylethyl (meth)acrylate; alkyl (meth)acrylates, which are (meth)acrylic acid alkyl esters such as methyl (meth)acrylate, ethyl (meth)acrylate, butyl (meth)acrylate, cyclohexyl (meth)acrylate, and lauryl (meth)acrylate; amino group-containing acrylates such as dimethylaminoethyl (meth)acrylate and quaternary compounds thereof; amide group-containing monomers such as (meth)acrylamide, dimethylacrylamide, and isopropylacrylamide; vinyl esters such as vinyl acetate; alkenes such as ethylene and propylene; aromatic vinyl monomers such as styrene; maleimide and maleimide derivatives such as phenylmaleimide and cyclohexylmaleimide; nitrile group-containing vinyl monomers such as (meth)acrylonitrile; aldehyde group-containing vinyl monomers such as (meth)acrolein; alkyl vinyl ethers such as methyl vinyl ether, ethyl vinyl ether, and butyl vinyl ether; other functional group-containing monomers such as vinyl chloride, vinylidene chloride, allyl alcohol, and vinylpyrrolidone; polyethylene glycol (meth)acrylates such as diethylene glycol (meth)acrylate, triethylene glycol (meth)acrylate, and dipropylene glycol (meth)acrylate; alkoxy polyalkylene glycol (meth)acrylates such as ethoxy-diethylene glycol (meth)acrylate, methoxy-triethylene glycol (meth)acrylate, 2-ethylhexyl-diethylene glycol (meth)acrylate, methoxy-polyethylene glycol (meth)acrylate, methoxy-dipropylene glycol (meth)acrylate, phenoxy-diethylene glycol (meth)acrylate, and phenoxy-polyethylene glycol (meth)acrylate; polyalkylene glycol chain-containing monomers such as monomers having a structure in which 1 to 300 mol of alkylene oxide is added to an unsaturated alcohol such as vinyl alcohol, (meth)allyl alcohol, or isoprenol; and monomers having a sulfonic acid group such as 3-allyloxy-2-hydroxypropanesulfonic acid, 2-acrylamido-2-methylpropanesulfonic acid, styrenesulfonic acid, or vinylsulfonic acid and salts thereof.

These different monomers may be used alone or in combination of two or more kinds.

In the polymer, the proportion of the structural unit derived from any of the different monomers is preferably 0 to 90 mol %, more preferably 0 to 80 mol %, still more preferably 0 to 60 mol %, based on 100 mol % of all structural units. Varying the types and amounts of the different monomers enables appropriate adjustment of the solubility of the polymer in the semiconductor cleaning agent composition and the cleaning performance of the semiconductor cleaning agent composition.

The polymer of the present disclosure has a weight average molecular weight of 3100 or more. The polymer having a weight average molecular weight of 3100 or more enables further enhancement of the ability to remove metal residues. The weight average molecular weight of the polymer is more preferably 4000 or more, still more preferably 5000 or more, most preferably 9000 or more. It is preferably 50000 or less, more preferably 24500 or less, still more preferably 23000 or less, still further more preferably 20000 or less. In other words, the weight average molecular weight of the polymer is preferably 3100 to 50000, more preferably 4000 to 24500, still more preferably 5000 to 23000, still further more preferably 5000 to 20000, particularly preferably 9000 to 20000.

The weight average molecular weight can be determined by measurement using gel permeation chromatography (GPC), specifically, by the method described in the EXAMPLES.

The amount of the polymer in the semiconductor cleaning agent composition of the present disclosure is preferably 0.01% by mass or more, more preferably 0.1% by mass or more, still more preferably 0.3% by mass or more, still further more preferably 0.8% by mass or more, based on the total amount of the semiconductor cleaning agent composition. It is preferably 10% by mass or less, more preferably 8% by mass or less, still more preferably 5% by mass or less. In other words, the amount of the polymer is preferably 0.01 to 10% by mass, more preferably 0.1 to 8% by mass, still more preferably 0.3 to 5% by mass, still further more preferably 0.8 to 5% by mass, based on the total amount of the semiconductor cleaning agent composition.

### Method of Producing Polymer

The polymer may be produced by any method capable of producing a polymer having a structural unit (A) derived from a carboxylic acid-based monomer. An example of the method is a method of polymerizing a monomer component containing any of the above carboxylic acid-based monomers and optional different monomers. The polymerization may be performed by any polymerization reaction, such as radical polymerization, cationic polymerization, or anionic polymerization. The polymerization reaction may be either photopolymerization or thermal polymerization.

The polymerization may be performed by any method. Examples thereof include a method of adding a polymerization initiator, a method of irradiating with UV light, a method of applying heat, and a method of irradiating with light in the presence of a polymerization initiator. In the polymerization, a polymerization initiator is preferably used.

Examples of the polymerization initiator include hydrogen peroxide; persulfates such as sodium persulfate, potassium persulfate, and ammonium persulfate; azo compounds such as dimethyl 2,2′-azobis(2-methylpropionate), 2,2′-azobis(isobutyronitrile), 2,2′-azobis(2-methylpropionamidine) dihydrochloride (i.e., 2,2′-azobis-2-amidinopropane dihydrochloride), 2,2′-azobis [N-(2-carboxyethyl)-2-methylpropionamidine]hydrate, 2,2′-azobis [2-(2-imidazolin-2-yl) propane], 2,2′-azobis [2-(2-imidazolin-2-yl) propane]dihydrochloride, 2,2′-azobis(1-imino-1-pyrrolidino-2-methylpropane) dihydrochloride, 2,2′-azobis(2,4-dimethylvaleronitrile), 2,2′-azodiisobutyronitrile, 2,2′-azobis(4-methoxy-2,4-dimethylvaleronitrile), dimethyl 2,2′-azobis(2-methylpropionate), and 2,2′-azobis(2-methylbutyronitrile); organic peroxides such as benzoyl peroxide, lauroyl peroxide, peracetic acid, di-t-butyl peroxide, and cumene hydroperoxide; and redox initiators that generate radicals by combining an oxidizing agent and a reducing agent, such as a combination of ascorbic acid and hydrogen peroxide or a combination of a persulfate and a metal salt. Of these polymerization initiators, hydrogen peroxide, persulfates, and azo compounds are preferred, and persulfates are more preferred, since they tend to reduce the amount of residual monomers.

These polymerization initiators may be used alone or in the form of a mixture of two or more kinds. The amount of the polymerization initiator(s) used is preferably 0.1 g or more and 30 g or less, more preferably 0.2 g or more and 20 g or less, still more preferably 0.25 g or more and 15 g or less, per 100 g of the monomer(s) used.

In the polymerization, a chain transfer agent may be used as a molecular weight regulator for the polymer, if necessary. Specific examples of the chain transfer agent include mercaptocarboxylic acids such as thioglycolic acid (mercaptoacetic acid), 3-mercaptopropionic acid, 2-mercaptopropionic acid (thiolactic acid), 4-mercaptobutanoic acid, thiomalic acid, salts thereof, and other compounds such as mercaptoethanol, thioglycerol, and 2-mercaptoethanesulfonic acid; halides such as carbon tetrachloride, methylene chloride, bromoform, and bromotrichloroethane; secondary alcohols such as isopropanol and glycerol; phosphorous acid, hypophosphorous acid, hypophosphites, and hydrates and the like thereof; hydrogen sulfite (salt) and compounds capable of generating hydrogen sulfite (salt) (e.g., bisulfurous acid (salt), pyrosulfurous acid (salt), dithionous acid (salt), sulfurous acid (salt)). Of these, hydrogen sulfite (salt), phosphorous acid (salt), and compounds having a mercapto group, such as mercaptocarboxylic acids are preferred, and hydrogen sulfite (salt) and phosphorous acid (salt) are more preferred.

The amount of the chain transfer agent used is preferably 0 mol % or more and 30 mol % or less, more preferably 0 mol % or more and 25 mol % or less, still more preferably 0 mol % or more and 20 mol % or less, most preferably 0 mol % or more and 10 mol % or less, based on 100 mol % of the amount of monomer(s) (all monomers) used.

The polymerization may be performed in a solvent. Any polymerization solvent may be used as long as the desired polymerization reaction proceeds. Preferred examples of a polymerization solvent capable of providing a polymer solution easy to use as is for preparing a semiconductor cleaning agent composition include water, alcohol solvents such as isopropyl alcohol, ether solvents such as propylene glycol monomethyl ether, amide solvents such as N-methylpyrrolidone, sulfur-containing solvents such as dimethyl sulfoxide, lactone solvents such as 8-valerolactone, and other water-soluble organic solvents.

In the polymerization, the polymerization temperature is preferably 40° C. or higher and 150° C. or lower. It is more preferably 50° C. or higher, still more preferably 55° C. or higher. Also, it is more preferably 120° C. or lower, still more preferably 110° C. or lower. In other words, the polymerization temperature is more preferably 50° C. to 120° C., still more preferably 55° C. to 110° C.

In the polymerization, the monomer component may be fed to a reaction vessel by any method. Examples thereof include a method of feeding the total amount of the monomer component into the reaction vessel all at once at the early stage of the polymerization; a method of feeding the total amount of the monomer component into the reaction vessel in portions or continuously; and a method including feeding a portion of the monomer component into the reaction vessel at the early stage of the polymerization and then feeding the remainder into the reaction vessel in portions or continuously. When any of the aforementioned polymerization initiators is used, it may be placed in the reaction vessel in advance or may be added dropwise to the reaction vessel, or these procedures may be combined depending on the purpose.

The polymerization time is preferably, but is not limited to, 30 to 600 minutes, more preferably 30 to 500 minutes, still more preferably 30 to 400 minutes.

The method of producing the polymer may include a different step in addition to the polymerization described above. Examples of the different step include aging, neutralization, dilution, drying, concentration, and purification. These steps can be performed by known methods.

### <pH Adjuster>

The semiconductor cleaning agent composition of the present disclosure contains a pH adjuster. The pH adjuster in the semiconductor cleaning agent composition of the present disclosure may be any compound that can adjust the pH to a desired level. Examples thereof include known acidic compounds and basic compounds. Of these, basic compounds are preferred from the viewpoint of cleaning performance.

In the preset disclosure, any basic compound may be used. Examples thereof include metal hydroxides such as an alkali metal hydroxide and an alkaline earth metal hydroxide; metal hydrogen carbonates such as an alkali metal hydrogen carbonate and an alkaline earth metal hydrogen carbonate; metal carbonates such as an alkali metal carbonate and an alkaline earth metal carbonate; and organic basic compounds, with metal hydroxides and organic basic compounds being particularly preferred.

A metal hydroxide preferably used in the present disclosure is an alkali metal hydroxide or an alkaline earth metal hydroxide. Specific examples include potassium hydroxide, sodium hydroxide, lithium hydroxide, calcium hydroxide, and magnesium hydroxide.

An organic basic compound particularly preferably used in the present disclosure is an amine compound. Specifically, the amine compound preferably includes at least one selected from the group consisting of compounds represented by the following formula (1) and compounds represented by the following formula (2).

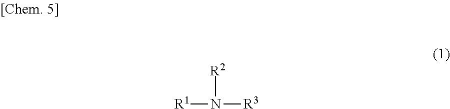

In the formula (1), R¹, R², and R³ are the same as or different from each other and each represent a hydrogen atom or a C1-C18 hydrocarbon group optionally having a substituent; and at least two selected from R¹, R², and R³ are optionally linked to each other to form a ring.

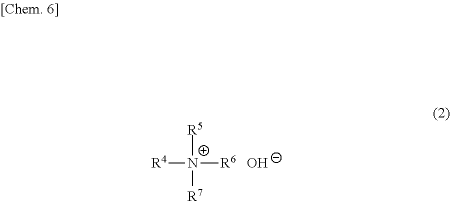

In the formula (2), R⁴, R⁵, R⁶, and R⁷ are the same as or different from each other and each represent a hydrogen atom or a C1-C18 hydrocarbon group optionally having a substituent.

In the amine compound in the present disclosure represented by the formula (1), the number of carbon atoms of the hydrocarbon group for R¹, R², and R³ is preferably 1 to 12, more preferably 1 to 8, still more preferably 1 to 4.

Examples of the hydrocarbon group include an aliphatic hydrocarbon group, an alicyclic hydrocarbon group, and an aromatic hydrocarbon group, with an aliphatic hydrocarbon group being preferred and an alkyl group being more preferred.

In the formula (1), the alkyl group for R¹, R², and R³ may be linear or branched.

Examples of the linear alkyl group include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, an n-hexadecyl group, an n-heptadecyl group, and an n-octadecyl group.

Examples of the branched alkyl group include a sec-butyl group, an isobutyl group, a tert-butyl group, a 1-methylbutyl group, a 1-ethylpropyl group, a 2-methylbutyl group, an isoamyl group, a 1,2-dimethylpropyl group, a 1,1-dimethylpropyl group, a tert-amyl group, a 1,3-dimethylbutyl group, a 3,3-dimethylbutyl group, a 1-methylpentyl group, a 1-methylbutyl group, a 1-ethylbutyl group, a 2-ethylbutyl group, a 2-ethyl-2-methylpropyl group, a sec-heptyl group, a tert-heptyl group, an isoheptyl group, a sec-octyl group, a tert-octyl group, an isooctyl group, a 1-ethylhexyl group, a 1-propylpentyl group, a 2-ethylhexyl group, and a 2-propylpentyl group.

Examples of a cyclic alkyl group include a cyclobutyl group, a cyclopentyl group, a cyclohexyl group, a cyclooctyl group, a cyclodecyl group, a cyclododecyl group, a cyclohexadecyl group, and a cyclooctadecyl group.

The hydrocarbon group may have a substituent. Non-limiting examples of the substituent include a hydroxy group, an alkoxy group, a halogen atom, an ether group, a cyano group, a thiol group, and an amino group. Preferred are a hydroxy group and an alkoxy group, and more preferred is a hydroxy group.

The number of substituents on the hydrocarbon group is preferably, but not limited to, 0 to 6, more preferably 0 to 3, from the viewpoint of a pH adjusting ability.

At least two selected from R¹, R², and R³ may be linked to form a ring. The ring formed may be saturated or unsaturated, and may be monocyclic or polycyclic. The ring may have a nitrogen atom. The ring may have a substituent. Examples of the substituent on the ring include the aforementioned substituents and alkyl groups.

Specific examples of the amine compound in the present disclosure represented by the formula (1) include alkylamines such as methylamine, dimethylamine, trimethylamine, ethylamine, diethylamine, triethylamine, ethylenediamine, N, N-diisopropylethylamine, tetramethylethylenediamine, and hexamethylenediamine; organic amines including aromatic amines such as aniline and toluidine and nitrogen-containing heterocyclic compounds such as pyrrole, pyridine, picoline, lutidine, and diazabicycloundecene; and alkanolamines such as monoethanolamine, diethanolamine, triethanolamine, monoisopropanolamine, N-methylethanolamine, and 2-(2-aminoethylamino) ethanol. Of these, alkanolamines are preferred.

In the amine compound in the present disclosure represented by the formula (2), the number of carbon atoms of the hydrocarbon group for R⁴, R⁵, R⁶, and R⁷ is preferably 1 to 18, more preferably 1 to 12, still more preferably 1 to 8, further more preferably 1 to 4.

Examples of the hydrocarbon group for R⁴, R⁵, R⁶, and R⁷ include an aliphatic hydrocarbon group, an alicyclic hydrocarbon group, and an aromatic hydrocarbon group. Of these, an aliphatic hydrocarbon group is preferred, and an alkyl group is more preferred.

In the formula (2), the alkyl group for R⁴, R⁵, R⁶, and R⁷ may be linear or branched. Non-limiting examples of the alkyl group include the same alkyl groups as those for R¹, R², and R³ described above.

The hydrocarbon group may have a substituent. Non-limiting examples of the substituent include a hydroxy group, an alkoxy group, a halogen atom, an ether group, a cyano group, and a thiol group. Preferred are a hydroxy group and an alkoxy group, and more preferred is a hydroxy group.

In the formula (2), the number of substituents in the hydrocarbon group for R⁴, R⁵, R⁶, and R⁷ is 1 or more, may be 2 or more, and is preferably 1 to 3.

Specific examples of the amine compound in the present disclosure represented by the formula (2) include quaternary ammonium salts such as tetramethylammonium hydroxide, tetraethylammonium hydroxide, tetrapropylammonium hydroxide, tetrabutylammonium hydroxide, benzyltrimethylammonium hydroxide, trimethyl-2-hydroxyethylammonium hydroxide (choline), dimethylbis(2-hydroxyethyl) ammonium hydroxide, and methyltris(2-hydroxyethyl) ammonium hydroxide.

The semiconductor cleaning agent composition of the present disclosure may contain only one type of pH adjuster or two or more types of pH adjusters.

The amount of the pH adjuster(s) in the semiconductor cleaning agent composition of the present disclosure is preferably 0.1% by mass or more, more preferably 0.3% by mass or more, still more preferably 0.5% by mass or more, based on the total amount of the semiconductor cleaning agent composition. It is preferably 20% by mass or less, more preferably 15% by mass or less, still more preferably 10% by mass or less.

In other words, the amount of the pH adjuster(s) is preferably 0.1 to 20% by mass, more preferably 0.3 to 15% by mass, further preferably 0.5 to 10% by mass, based on the total amount of the semiconductor cleaning agent composition.

The amount of the pH adjuster(s) per 100 parts by mass of the polymer is preferably 10 to 2000 parts by mass, more preferably 20 to 1800 parts by mass, still more preferably 25 to 1700 parts by mass.

### <Different Ingredient>

The semiconductor cleaning agent composition of the present disclosure may contain a different ingredient(s) in addition to the aforementioned ingredients. Non-limiting examples of the different ingredient(s) include color transfer inhibitors, softeners, fragrances, solubilizers, fluorescent agents, colorants, foaming agents, foam stabilizers, polishing agents, disinfectants, bleaching agents, bleaching aids, enzymes, dyes, dispersants, and solvents.

The semiconductor cleaning agent composition of the present disclosure preferably contains an optional dispersant. The semiconductor cleaning agent composition may contain any dispersant, and preferably contains a nonionic dispersant in order to further enhance the ability to remove metal residues.

Non-limiting examples of the nonionic dispersant include polyvinylpyrrolidone, polydimethylacrylamide, polyethylene glycol, polypropylene glycol, polyalkylene glycol, polyglycerol, polyoxyethylene alkyl ethers, polyoxyalkylene alkyl ethers, polyoxyethylene lauryl ether, polyoxyethylene cetyl ether, polyoxyethylene stearyl ether, polyoxyethylene oleyl ether, polyoxyethylene higher alcohol ethers, polyoxyethylene octylphenyl ether, polyoxyethylene nonylphenyl ether, polyoxyalkylene alkyl ethers, polyoxyethylene derivatives, polyoxyethylene sorbitan monolaurate, polyoxyethylene sorbitan monopalmitate, polyoxyethylene sorbitan monostearate, polyoxyethylene sorbitan tristearate, polyoxyethylene sorbitan monooleate, polyoxyethylene sorbitan trioleate, polyoxyethylene sorbitan tetraoleate, polyethylene glycol monolaurate, polyethylene glycol monostearate, polyethylene glycol distearate, polyethylene glycol monooleate, polyoxyethylene alkylamines, polyoxyethylene hydrogenated castor oil, and alkyl alkanolamides. In particular, the semiconductor cleaning agent composition preferably contains as the nonionic dispersant a compound represented by the following formula (3) or (4) or a polymer of N-vinyl lactam typified by N-vinylpyrrolidone, and more preferably contains a compound represented by the formula (3) and/or a compound represented by the formula (4).

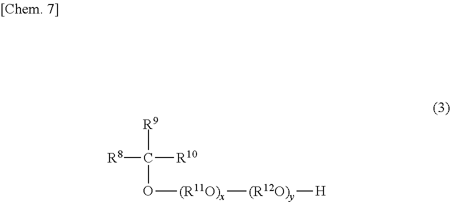

In the formula (3), R⁸, R⁹, and R¹⁰ are the same as or different from each other and each represent a hydrogen atom or an alkyl group; R¹¹ and R¹² are the same as or different from each other and each represent an alkylene group; x and y are the same as or different from each other and each represent an integer of 0 to 50; and (x+y) is an integer of 1 or more.

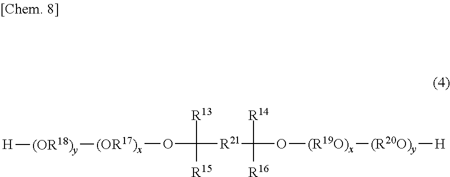

In the formula (4), R¹³, R¹⁴, R¹⁵, and R¹⁶ are the same as or different from each other and each represent a hydrogen atom or an alkyl group; R¹⁷, R¹⁸, R¹⁹, R²⁰, and R²¹ are the same as or different from each other and each represent an alkylene group or an alkynylene group; x and y are the same as or different from each other and each represent an integer of 0 to 50; and (x+y) is an integer of 1 or more.

In the formula (3), the alkyl group for R⁸, R⁹, and R¹⁰ may be linear or branched. The number of carbon atoms in the alkyl group in the formula (3) is preferably 1 or more, more preferably 2 or more, still more preferably 3 or more. It is preferably 20 or less, more preferably 18 or less, still more preferably 12 or less. In other words, the number of carbon atoms in the alkyl group for R⁸, R⁹, and R¹⁰ in the formula (3) is preferably 1 to 20, more preferably 2 to 18, still more preferably 3 to 12.

Examples of the alkyl group in the formula (3) include linear or branched alkyl groups such as a methyl group, an ethyl group, an n-propyl group, an isopropyl group, an n-butyl group, a tert-butyl group, a sec-butyl group, an isobutyl group, a pentyl group, an isopentyl group, a neopentyl group, a hexyl group, a 2-methylpentyl group, a 3-methylpentyl group, a 2,2-dimethylbutyl group, a 2,3-dimethylbutyl group, a heptyl group, a 2-methylhexyl group, a 3-methylhexyl group, a 2,2-dimethylpentyl group, a 2,3-dimethylpentyl group, a 2,4-dimethylpentyl group, a 3-ethylpentyl group, a 2,2,3-trimethylbutyl group, an octyl group, a methylheptyl group, a dimethylhexyl group, a 2-ethylhexyl group, a 3-ethylhexyl group, a trimethylpentyl group, a 3-ethyl-2-methylpentyl group, a 2-ethyl-3-methylpentyl group, a 2,2,3,3-tetramethylbutyl group, a nonyl group, a decyl group, an undecyl group, a dodecyl group, a tridecyl group, a tetradecyl group, a pentadecyl group, a hexadecyl, a heptadecyl, an octadecyl group, a nonadecyl group, and an icosyl group.

In the formula (3), the alkylene group for R¹¹ and R¹² may be linear or branched. Examples of the alkylene group for R¹¹ and R¹² in the formula (3) include a methylene group, an ethylene group, an n-propylene group, a 2-propylene group, an n-butylene group, a pentamethylene group, a hexamethylene group, a neopentylene group, a heptamethylene group, an octamethylene group, a nonamethylene group, a decamethylene group, a methylmethylene group, a methylethylene group, a 1-methylpentylene group, and a 1,4-dimethylbutylene group. The alkylene group is preferably a C2-C4 alkylene group, more preferably a C2-C3 alkylene group. This tends to prevent or reduce adhesion of metal residues to the wafer surface.

In the formula (3), x and y may be the same as or different from each other and are each a number from 0 to 50, preferably 0 to 40, more preferably 0 to 30, still more preferably 0 to 25, still further more preferably 0 to 20.

In the formula (3), x represents the average number of moles of alkylene oxide (R¹¹O) added, and y represents the average number of moles of alkylene oxide (R¹²O) added. In these alkylene oxides, x and y may be the same as or different from each other.

In the formula (3), x is preferably a number of 0 to 30, more preferably 0 to 25, still more preferably 0 to 20, and y is preferably a number of 0 to 20, more preferably 0 to 15, still more preferably 0 to 10. Here, x and y are each preferably an integer of 1 or more. This tends to facilitate control of the hydrophilicity and hydrophobicity. In the formula (3), two or more of R⁸, R⁹, and R¹⁰ are preferably alkyl groups in order to achieve a compact molecular structure and high permeability.

Examples of the alkyl group for R¹³, R¹⁴, R¹⁵, and R¹⁶ in the formula (4) include the same alkyl groups as those represented by R⁸, R⁹, and R¹⁰ described above.

The number of carbon atoms in the alkyl group in the formula (4) is preferably 1 or more, more preferably 2 or more. It is preferably 20 or less, more preferably 18 or less, still more preferably 12 or less.

Examples of the alkylene group for R¹⁷, R¹⁸, R¹⁹, R²⁰, and R²¹ in the formula (4) include the same alkylene groups as those represented by R¹¹ and R¹² described above. The alkylene group is preferably a C2-C4 alkylene group, more preferably a C2-C3 alkylene group.

Examples of the alkynylene group for R¹⁷, R¹⁸, R¹⁹, R²⁰, and R²¹ in the formula (4) include an ethynylene group (—C≡C—), a propynylene group (—C≡C—CH₂—), a 1-butynylene group (—C≡C—CH₂—CH₂—), and a 2-butynylene group (—CH₂—C≡C—CH₂—). Of these, C2-C6 alkynylene groups are preferred, and C2-C4 alkynylene groups are more preferred.

In the formula (4), x and y may be the same as or different from each other and are each a number of 0 to 50, preferably 0 to 40, more preferably 0 to 30, still more preferably 0 to 25, still further more preferably 0 to 20.

In the formula (4), x represents the average number of moles of alkylene oxide (R¹⁷O) added and the average number of moles of alkylene oxide (R¹⁹O) added, and y represents the average number of moles of alkylene oxide (R¹⁸O) added and the average number of moles of alkylene oxide (R²⁰O) added. In these alkylene oxides, x and y may be the same as or different from each other.

In the formula (4), x is preferably a number of 1 to 30, more preferably 1 to 20, still more preferably 1 to 18, and y is preferably a number of 0 to 30, more preferably 0 to 20, still more preferably 0 to 10. Here, x and y are each preferably an integer of 1 or more.

The semiconductor cleaning agent composition of the present disclosure may contain a solvent. Examples of the solvent include water, lower alcohols, ether solvents, amide solvents, sulfur-containing solvents, lactone solvents, and other water-soluble organic solvents. These solvents may be the same as the polymerization solvents described above. Of these, the solvent preferably contains water. The solvent may be a mixture containing two or more of these.

The amount of the solvent in the semiconductor cleaning agent composition of the present disclosure is preferably 0 to 30% by mass, more preferably 0 to 20% by mass, still more preferably 0 to 10% by mass, based on the total amount of the semiconductor cleaning agent composition.

The amount of different ingredient(s) other than the solvent in the semiconductor cleaning agent composition of the present disclosure is preferably 0.001% by mass or more, more preferably 0.01% by mass or more, still more preferably 0.02% by mass or more, based on the total amount of the semiconductor cleaning agent composition. It is preferably 20% by mass or less, more preferably 10% by mass or less, still more preferably 5% by mass or less. In other words, the amount of the different ingredient(s) other than the solvent is preferably 0.001 to 20% by mass, more preferably 0.01 to 10% by mass, still more preferably 0.02 to 5% by mass, based on the total amount of the semiconductor cleaning agent composition.

In one or a plurality of embodiments, the amounts of the ingredients in the semiconductor cleaning agent composition of the present disclosure, such as the polymer, the pH adjuster(s), and the different ingredient(s), refer to the amounts of the ingredients in the semiconductor cleaning agent composition to be used in a cleaning step, i.e., at the start of use for cleaning (which may also be referred to as at the time of use or at the time of cleaning).

The semiconductor cleaning agent composition of the present disclosure may be prepared as a concentrate in which the volume is reduced to the extent that separation, precipitation, or the like does not occur and storage stability is not impaired. The concentrated semiconductor cleaning agent composition is preferably one concentrated 5 times or more in terms of transportation costs, and preferably one concentrated 100 times or less in terms of storage stability.

The concentrated semiconductor cleaning agent composition of the present disclosure may be diluted with water at the time of use so that the amounts of the ingredients fall within the aforementioned ranges (i.e., the amounts at the time of cleaning). Furthermore, the concentrated semiconductor cleaning agent composition may be used by adding the ingredients separately at the time of use. In the present disclosure, the phrases “at the time of use” and “at the time of cleaning” of the concentrated semiconductor cleaning agent composition refer to a state in which the concentrated semiconductor cleaning agent composition is diluted.

The semiconductor cleaning agent composition of the present disclosure has a pH of 7 or higher. The semiconductor cleaning agent composition having a pH of 7 or higher can have a further enhanced ability to remove metal residues. The pH is more preferably 8 or higher, still more preferably 9 or higher, still further more preferably 11 or higher, in that the ability to reduce metal residues can be enhanced. It is preferably 14 or lower, more preferably 13.8 or lower, still more preferably 13.6 or lower. The pH is preferably 7 to 14, more preferably 8 to 13.8, still more preferably 9 to 13.6, still further more preferably 11 to 13.6.

The pH can be determined by measurement at 23° C. using a pH meter.

### Method of Producing Semiconductor Cleaning Agent Composition

The semiconductor cleaning agent composition of the present disclosure may be produced by any known method. An example of the method is a method of mixing and dispersing the aforementioned ingredients using any of various apparatuses such as mixers and dispersers. The mixing and dispersing may be performed by any known method. In addition, a different step that is typically performed may also be included.

### Method of Using

The semiconductor cleaning agent composition of the present disclosure is preferably used in a cleaning step after the CMP process in the semiconductor manufacturing process. On the surface of the semiconductor substrate after the CMP process, polishing debris and organic residues from metal wiring, protective films, insulating films, and the like may remain. Furthermore, the chemical polishing agent used in the CMP process may remain. Such residues remaining on the substrate surface after the CMP process can be well removed by cleaning the substrate surface with the semiconductor cleaning agent composition of the present disclosure.

Non-limiting examples of the metal wiring, protective films, and insulating films include known metal wiring, protective films, and insulating films that are commonly used in the semiconductor manufacturing process.

Non-limiting examples of the chemical polishing agent include known ones such as slurries of abrasive grains made of metal oxides such as CeO₂, Fe₂O₃, SnO₂, MnO, and SiO₂.

The semiconductor cleaning agent composition of the present disclosure can remove well the aforementioned residues, and is particularly excellent in removing CeO₂ (ceria).

The cleaning of the substrate surface after the CMP process with the semiconductor cleaning agent composition of the present disclosure may be performed by any known method. Examples of the method include a method in which the substrate after the CMP process is immersed in the semiconductor cleaning agent composition for cleaning and a spin or spray cleaning method.

The semiconductor cleaning agent composition may be used at any temperature, and it is preferably used, for example, at 20° C. to 90° C., more preferably 20° C. to 70° C., still more preferably 20° C. to 50° C., from the viewpoint of cleaning efficiency.

### EXAMPLES

The present invention is described in more detail below with reference to examples. However, the scope of the present invention is not limited to these examples. All modifications and variations that do not depart from the spirit and scope of the present invention are intended to be included within the technical scope of the present invention. Unless otherwise specified, “%” and “wt %” mean “% by mass”.

### <Measurement Condition 1 for Weight Average Molecular Weight (Mw)>

Apparatus: Waters Alliance e2695 (RI: 2414 PDA: 2998)
Column: Asahipak GF-7M HQ×2, Asahipak GF-1G 7B
Eluent: 0.1 M aqueous sodium acetate solution (pH 7.4)
Flow rate: 0.5 mL/min
Temperature: 40° C.
Calibration curve: Polyacrylic acid standard available from American Polymer Standards Corporation

### <Measurement Condition 2 for Weight Average Molecular Weight (Mw)>

Apparatus: HLC-8320GPC available from Tosoh Corporation
Detector: RI
Column: TSK-GEL G3000PWXL available from Tosoh Corporation
Column temperature: 35° C.
Flow rate: 0.5 ml/min
Calibration curve: poly-sodium acrylate standard available from SOHWA Science inc.
Eluent: a solution prepared by diluting a mixture of sodium dihydrogenphosphate dodecahydrate/disodium hydrogenphosphate dihydrate (34.5 g/46.2 g) with 5000 g of pure water.

### Synthesis of Polymer

### Synthesis Example 1

A 5 L stainless steel reaction vessel equipped with a reflux condenser and a stirrer was charged with 1785 g of ion-exchanged water, and the temperature was raised to reach boiling reflux conditions with stirring. Then, 504 g of 80% acrylic acid (hereinafter referred to as AA) and 167 g of 15% sodium persulfate (hereinafter referred to as NaPS) were added dropwise from different nozzles into the polymerization reaction system under boiling reflux conditions with stirring. For the respective solutions, the dropwise addition times of the 80% AA, 15% NaPS, and ion-exchanged water were 180 minutes, 185 minutes, and 170 minutes, respectively. After the completion of the dropwise addition of the 15% NaPS solution, the reaction solution was maintained under boiling reflux conditions (aged) for an additional 30 minutes to complete the polymerization. Thereby, a polymer-containing aqueous polymer solution 1 was obtained. The obtained polymer had a weight average molecular weight of 14100 (measurement condition 1).

### Synthesis Example 2

A 2.5 L stainless steel separable flask equipped with a reflux condenser, a stirrer (paddle blade), and a thermometer was charged with 329.0 g of pure water (initial charge), and the temperature was raised to its boiling point with stirring. Then, with stirring, into the polymerization reaction system under boiling reflux conditions, 900.0 g (i.e., 10.0 mol) of an 80% by mass aqueous acrylic acid solution (hereinafter referred to as “80% AA”) was added dropwise over 180 minutes, 59.2 g of a 15% by mass aqueous sodium persulfate solution (hereinafter referred to as “15% NaPS”) was added dropwise over 195 minutes, and a 45% by mass aqueous sodium hypophosphite solution (hereinafter referred to as “45% SHP”) was added dropwise in two stages at different rates: first, 21.4 g over 18 minutes, followed by 84.8 g over 162 minutes, from the tip nozzles through separate supply paths. Each component was added continuously at a constant rate except for the 45% SHP. After the completion of the dropwise addition of the 80% AA, the reaction solution was maintained under boiling reflux condition (aged) for an additional 30 minutes to complete the polymerization. After the completion of the polymerization, 411.8 g of pure water was added to the reaction solution to obtain an aqueous polymer solution 2. The obtained polymer had a weight average molecular weight of 4100 (measurement condition 2).

### Synthesis Example 3

A 5 L stainless steel separable flask equipped with a reflux condenser, a stirrer (paddle blade), and a thermometer was charged with 404 g of pure water and 0.0159 g of Mohr's salt, and the temperature was raised to 90° C. with stirring.

Then, with stirring, 1040 g of 80% AA, 48.1 g of a 48% aqueous NaOH solution, 144.8 g of 15% NaPS, and 171 g of 35% sodium hydrogen sulfite (hereinafter referred to as SBS) were added from different nozzles.

For the respective solutions, the dropwise addition times of the 80% AA and the 48% aqueous NaOH solution were each 180 minutes, and the dropwise addition times of the 15% NaPS and the 35% aqueous SBS solution were each 185 minutes. After the completion of the dropwise addition of the 15% NaPS, the contents were aged for 30 minutes to complete the polymerization, thereby obtaining an aqueous polymer solution 3. The obtained polymer had a weight average molecular weight of 5700 (measurement condition 1).

### Synthesis Example 4

A 5 L stainless steel separable flask equipped with a reflux condenser, a stirrer, and a thermometer was charged with 622 g of ion-exchanged water and 414 g of maleic anhydride. Then, 703.6 g of a 48 wt % aqueous sodium hydroxide solution (hereinafter referred to as 48% NaOHaq) was gradually added thereto with stirring. Thereafter, the aqueous solution in the flask was heated to its boiling point under atmospheric pressure with stirring. Then, with stirring, 469 g of an 80 wt % aqueous acrylic acid solution (hereinafter referred to as 80% AA), 106.6 g of a 35 wt % aqueous hydrogen peroxide solution (hereinafter referred to as 35% H₂O₂), 131.1 g of a 15 wt % aqueous sodium persulfate solution (hereinafter referred to as 15% NaPS), and 217 g of ion-exchanged water were added dropwise from different nozzles. The 80% AA was added dropwise over 260 minutes, the 15% NaPS and the 35% H₂O₂ were started to be added dropwise at the same time as the 80% AA and added dropwise over 260 minutes, and ion-exchanged water was started to be added 150 minutes after the start of the dropwise addition of the 80% AA and added dropwise over 140 minutes. After the completion of all the dropwise additions, the reaction solution was maintained under boiling reflux condition for an additional 20 minutes to complete the polymerization. Thereby, an acrylic acid-maleic acid copolymer (salt) was obtained. Thereafter, the pH of the acrylic acid-maleic acid copolymer (salt) was adjusted to 7.5 with a 48 wt % aqueous NaOH solution. The obtained polymer had a weight average molecular weight of 5600 (measurement condition 1).

### Synthesis Example 5

A 5 L stainless steel separable flask equipped with a reflux condenser, a stirrer (paddle blade), and a thermometer was charged with 1120 g of ion-exchanged water, and the temperature was raised to reach boiling reflux conditions with stirring. Then, 1480 g of 37% sodium acrylate (hereinafter referred to as SA), 65 g of a 15% aqueous NaPS solution, and 157 g of ion-exchanged water were added dropwise from different nozzles into the polymerization reaction system under boiling reflux conditions with stirring. For the respective solutions, the dropwise addition time of the 37% SA was 140 minutes, and the dropwise addition times of the 15% NaPS and ion-exchanged water were each 145 minutes. The obtained polymer had a weight average molecular weight of 3000 (measurement condition 2).

### Synthesis Example 6

A 5 L stainless steel separable flask equipped with a reflux condenser, a stirrer, and a thermometer was charged with 381 g of ion-exchanged water and 242.6 g of maleic anhydride. Then, 408.5 g of a 48 wt % aqueous sodium hydroxide solution (hereinafter referred to as 48% NaOHaq) was gradually added thereto with stirring. Thereafter, the aqueous solution in the flask was heated to its boiling point under atmospheric pressure with stirring. Then, with stirring, 498 g of an 80 wt % aqueous acrylic acid solution (hereinafter referred to as 80% AA), 122.4 g of a 35 wt % aqueous hydrogen peroxide solution (hereinafter referred to as 35% H₂O₂), 157.3 g of a 15 wt % aqueous sodium persulfate solution (hereinafter referred to as 15% NaPS), and 250 g of ion-exchanged water were added dropwise from different nozzles. The 80% AA and the 35% H₂O₂ were each added dropwise over 240 minutes, the 15% NaPS was started to be added dropwise at the same time as the 80% AA and added dropwise over 250 minutes, and ion-exchanged water was started to be added 110 minutes after the start of the dropwise addition of the 80% AA and added dropwise over 160 minutes. After the completion of all the dropwise additions, the reaction solution was maintained under boiling reflux condition for an additional 30 minutes to complete the polymerization. Thereby, an acrylic acid-maleic acid copolymer (salt) was obtained. Thereafter, the pH of the acrylic acid-maleic acid copolymer (salt) was adjusted to 8.5 with an aqueous NaOH solution. The obtained polymer had a weight average molecular weight of 10,700 (measurement condition 1).

### Examples 1 to 9, Comparative Examples 1 and 2

As shown in Table 1, water, a polymer, and a nonionic dispersant as a different additive were mixed, and a pH adjuster was added thereto to achieve a predetermined pH, thereby preparing a cleaning agent composition. The nonionic dispersant was added in an amount of 0.25% by mass based on 100% by mass of the total amount of the cleaning agent composition. Water and a pH adjuster were added to the composition appropriately to achieve the pH shown in Table 1, thereby preparing a cleaning agent.

### (Method of Preparing Contaminated Coupon)

A wafer with a TEOS film purchased from Kyushu Semiconductor Co., Ltd. was cut into a 1.5 cm square. A CeO₂ slurry purchased from Showa Denko Materials Co., Ltd. (HS0220 available from Showa Denko Materials Co., Ltd.) was diluted 100 times to prepare a contaminating solution. The cut wafer was immersed in the contaminating solution for one minute. After the immersion, the wafer was immersed in ultrapure water in a PFA pot for 30 seconds, and then rinsed with ultrapure water for at least 5 minutes.

The wafer was dried to prepare a contaminated coupon.

### (Cleaning Treatment)

Cleaning was performed as follows: the cleaning agent composition (30 ml) prepared in each of the examples was placed in a PFA vessel; the contaminated substrate was immersed in the cleaning agent composition and subjected to ultrasonic irradiation (processing conditions: output of 40 KHz) for two minutes using an ultrasonic device (S8500 available from Branson). After the ultrasonic treatment, the substrate was rinsed with ultrapure water for five minutes and then naturally dried.

### (Method of Calculating Cleaning Rate)

Before and after the cleaning, the surface of the TEOS film substrate was analyzed by an X-ray photoelectron spectrometer under the following conditions.
Apparatus: AXIS-NOVA available from Shimadzu Corporation
Measurement conditions/excitation source: Al Kα 12 mA 12 kV, Pass Energy: 160 eV

The surface element ratio of Ce element was quantified from the peak area ratio using Vision 2 Processing software (KRATOS ANALYTICAL). The cleaning performance was determined based on the difference (%) in the amount of Ce element present on the substrate surface before and after cleaning. The cleaning rate was calculated according to the following formula.

$$Cleaning rate ( \% ) = ( Percentage of Ce on substrate after cleaning - Percentage of Ce on substrate before cleaning ) / Percentage of Ce on substrate before cleaning \times 100$$

The cleaning rate (%) was evaluated according to the following criteria.
Cleaning rate (%) was higher than 95% and not higher than 100%: 00 (Excellent)
Cleaning rate (%) was higher than 90% and not higher than 95%: 0 (Good)
Cleaning rate (%) was not higher than 90%: x (Poor)

TABLE 1

| | Cleaning composition | | | | | | |
|---|---|---|---|---|---|---|---|
| | Polymer | | | | | | Evaluation |
| | | | Amount | | pH | | Cleaning |
| | entry | Mw | wt % | Different additive | Adjuster | pH | performance |
| Example 1 | Synthesis | 4100 | 2 | Nonionic dispersant (i) | AH212 | 12 | ∘∘ |
| | Example 2 | | | | | | |
| Example 2 | Synthesis | 5700 | 2 | Nonionic dispersant (i) | AH212 | 12 | ∘∘ |
| | Example 3 | | | | | | |
| Example 3 | Synthesis | 14100 | 1 | Nonionic dispersant (i) | AH212 | 11 | ∘∘ |
| | Example 1 | | | | | | |
| Example 4 | Synthesis | 14100 | 1 | Nonionic dispersant (i) | MEA | 11 | ∘∘ |
| | Example 1 | | | | | | |
| Example 5 | Synthesis | 14100 | 0.5 | Nonionic dispersant (i) | MEA | 11 | ∘ |
| | Example 1 | | | | | | |
| Example 6 | Synthesis | 14100 | 1 | Nonionic dispersant (i) | MEA | 10 | ∘ |
| | Example 1 | | | | | | |
| Example 7 | Synthesis | 5600 | 1 | Nonionic dispersant (i) | MEA | 11 | ∘∘ |
| | Example 4 | | | | | | |
| Example 8 | Synthesis | 10700 | 1 | Nonionic dispersant (i) | MEA | 11 | ∘∘ |
| | Example 6 | | | | | | |
| Example 9 | Synthesis | 14100 | 1 | — | AH212 | 11 | ∘ |
| | Example 1 | | | | | | |
| Comparative | Synthesis | 3000 | 0.5 | Nonionic dispersant (i) | MEA | 11 | x |
| Example 1 | Example 5 | | | | | | |
| Comparative | Water | — | | | | | x |
| Example 2 | | | | | | | |

The compounds in Table 1 are as follows:
MEA: monoethanolamine
AH212: Dimethylbis(2-hydroxyethyl) ammonium hydroxide
Nonionic dispersant (i): a mixture of compounds represented by the following formula:

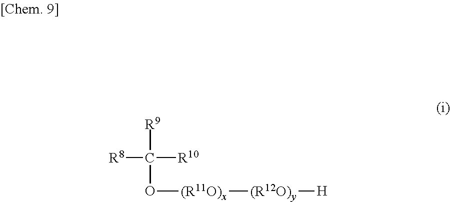

wherein R⁸ is H; R⁹ and R¹⁰ are each a C1-C12 linear alkyl group, with the total number of carbon atoms of R⁹ and R¹⁰ being 11 to 13; R¹¹ is —C₂H₄—; R¹² is —CH₂CH(CH₃)—; and x=12 and y=3, where x and y each represent the average number of moles added.

The results in Table 1 demonstrated that the cleaning agent compositions of the examples have a high ability to remove ceria particles.

1. A semiconductor cleaning agent composition, comprising:
a polymer having a structural unit derived from a carboxylic acid-based monomer; and
a pH adjuster,
the polymer having a weight average molecular weight of 3100 or more,
the pH adjuster being one or more compounds selected from the group consisting of a metal hydroxide and an amine compound, and
the semiconductor cleaning agent composition having a pH of 7 or higher.

2. The semiconductor cleaning agent composition according to claim 1,
wherein the amine compound comprises one or more compounds selected from the group consisting of compounds represented by the following formula (1) and compounds represented by the following formula (2): 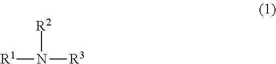
wherein R¹, R², and R³ are the same as or different from each other and each represent a hydrogen atom or a C1-C18 hydrocarbon group optionally having a substituent; and at least two selected from R¹, R², and R³ are optionally linked to each other to form a ring, 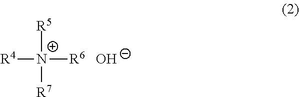
wherein R⁴, R⁵, R⁶, and R⁷ are the same as or different from each other and each represent a hydrogen atom or a C1-C18 hydrocarbon group optionally having a substituent.

3. The semiconductor cleaning agent composition according to claim 1, comprising at least one of a compound represented by the following formula (3) or a compound represented by the following formula (4): 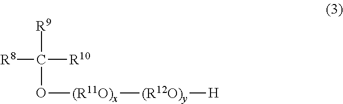
wherein R⁸, R⁹, and R¹⁰ are the same as or different from each other and each represent a hydrogen atom or an alkyl group; R¹¹ and R¹² are the same as or different from each other and each represent an alkylene group; x and y are the same as or different from each other and each represent an integer of 0 to 50; and (x+y) is an integer of 1 or more, 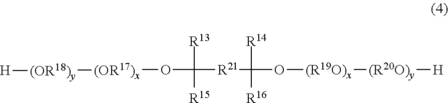
wherein R¹³, R¹⁴, R¹⁵, and R¹⁶ are the same as or different from each other and each represent a hydrogen atom or an alkyl group; R¹⁷, R¹⁸, R¹⁹, R²⁰, and R²¹ are the same as or different from each other and each represent an alkylene group or an alkynylene group; x and y are the same as or different from each other and each represent an integer of 0 to 50; and (x+y) is an integer of 1 or more.
